(19) United States
(12) Patent Application Publication
(10) Pub. No.: US 2013/0133053 A1
(43) Pub. Date: May 23, 2013

(54) METHODS FOR ENHANCING PASSWORD AUTHENTICATION AND DEVICES THEREOF

(71) Applicant: Chandra Sekhar Sreerama Naga Akunuru, Hyderabad (IN)

(72) Inventor: Chandra Sekhar Sreerama Naga Akunuru, Hyderabad (IN)

(73) Assignee: INFOSYS LIMITED, Bangalore (IN)

(21) Appl. No.: 13/414,917

(22) Filed: Mar. 8, 2012

(30) Foreign Application Priority Data
Nov. 21, 2011 (IN) 3974/CHE/2011

(51) Int. Cl. G06F 21/00; G06F 7/04

(52) U.S. Cl. 726/7

(57) ABSTRACT

This technology includes identifying verification password characters and a location of each of the verification password characters in one of a plurality of rows and one of a plurality of columns of a password matrix in response to received login identifier characters and received password characters from a client computing device. A determination is made whether each of the received password characters and the location of each of the received password characters in the password matrix matches each of the identified verification password characters and the location of each of the identified verification password characters in the password matrix. Access to the client computing device is granted when each of the received password characters and the location of each of the received password characters in the password matrix is determined to match each of the identified verification password characters and the location of each of the identified verification password characters.

### FIELD

This technology generally relates to methods and devices for authentication and, more particularly, methods for enhancing password authentication and devices thereof.

### BACKGROUND

A password is a string of characters, such as a secret word, used for authentication to prove identity or gain access to a resource. Typically, when a user at a client computing device requests access to a secure application, the responding server will initially provide a login page with fields for a username or login identifier and a password. The user at the client computing device enters the username or login identifier and the password which is transmitted to the responding server to determine whether or not to authenticate the user. Accordingly, this type of traditional login procedure provides some level of security to prevent unauthorized users from accessing the secure application at the responding server. Unfortunately, there are still problems with this type of authentication.

For example, if the username or login identifier is known or easily determined there are a number of techniques, such as brute force, dictionary attacks, pattern checking, and word list substitution, which can be used to obtain the password. Once the password has been obtained, unauthorized users at other client computing devices will now be able to access the secure application at the responding server.

### SUMMARY

A method for enhancing password authentication includes identifying by a secured computing apparatus verification password characters and a location of each of the verification password characters in one of a plurality of rows and one of a plurality of columns of a password matrix in response to received login identifier characters and received password characters from a client computing device. A determination is made by the secured computing apparatus whether each of the received password characters and the location of each of the received password characters in the password matrix matches each of the identified verification password characters and the location of each of the identified verification password characters in the password matrix. Access to the client computing device is granted by the secured computing apparatus when each of the received password characters and the location of each of the received password characters in the password matrix is determined to match each of the identified verification password characters and the location of each of the identified verification password characters in the password matrix.

A non-transitory computer readable medium having stored thereon instructions for enhancing password authentication comprising machine executable code which when executed by at least one processor, causes the processor to perform steps including identifying verification password characters and a location of each of the verification password characters in one of a plurality of rows and one of a plurality of columns of a password matrix in response to received login identifier characters and received password characters from a client computing device. A determination is made whether each of the received password characters and the location of each of the received password characters in the password matrix matches each of the identified verification password characters and the location of each of the identified verification password characters in the password matrix. Access to the client computing device is granted when each of the received password characters and the location of each of the received password characters in the password matrix is determined to match each of the identified verification password characters and the location of each of the identified verification password characters in the password matrix.

A secured computing apparatus includes a memory coupled to one or more processors which are configured to execute programmed instructions stored in the memory including identifying verification password characters and a location of each of the verification password characters in one of a plurality of rows and one of a plurality of columns of a password matrix in response to received login identifier characters and received password characters from a client computing device. A determination is made whether each of the received password characters and the location of each of the received password characters in the password matrix matches each of the identified verification password characters and the location of each of the identified verification password characters in the password matrix. Access to the client computing device is granted when each of the received password characters and the location of each of the received password characters in the password matrix is determined to match each of the identified verification password characters and the location of each of the identified verification password characters in the password matrix.

This technology provides a number of advantages including providing methods and devices enhancing password authentication. With this technology, it becomes very difficult, if not impossible, to gain unauthorized access even when access to the password itself is obtained.

### BRIEF DESCRIPTION OF THE DRAWINGS

FIG. 1 is an environment with an exemplary secured computing apparatus;

FIG. 2 is a flow chart of an exemplary method for enhancing password authentication;

FIGS. 3A-3F are diagrams of various exemplary password matrix.

### DETAILED DESCRIPTION

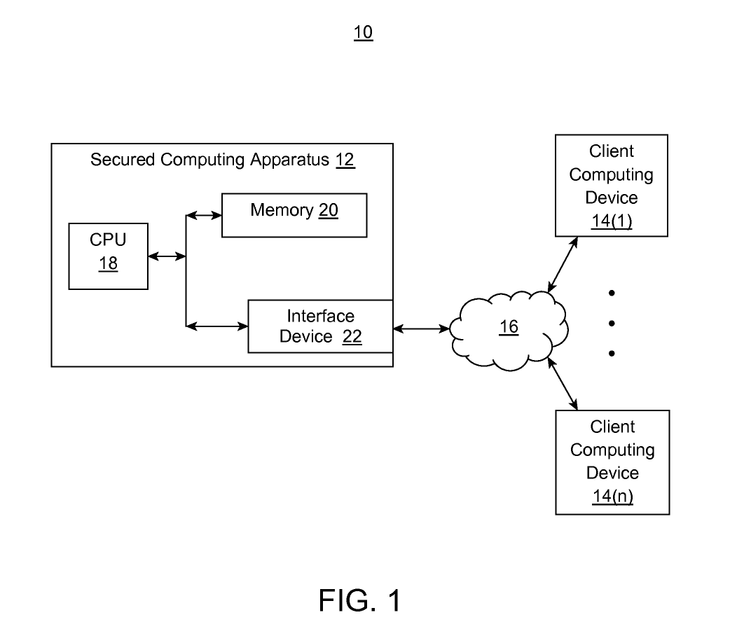

An environment 10 with an exemplary secured computing apparatus 12 is illustrated in FIG. 1. The environment 10 includes the secured computing apparatus 12 and client computing devices 14(1)-14(n) which are all coupled together by a communication network 16, although this environment can include other types and numbers of systems, devices, components, and elements in other configurations, such as multiple numbers of each of these apparatuses and devices. This technology provides a number of advantages including providing methods and devices that dynamically adapt provided services on a client computing device to current usage.

In this example, the secured computing apparatus 12 is a server running a secure application which requires a login identification and password to gain access to the application, although other types and numbers of computing devices could be used. The secured computing apparatus 12 includes a central processing unit (CPU) or processor 18, a memory 20, and an interface device 22 which are coupled together by a bus or other link, although other numbers and types of systems, devices, components, and elements in other configurations and locations can be used. The processor 18 executes a program of stored instructions for one or more aspects of the present technology as described and illustrated by way of the examples herein, although other types and numbers of processing devices and logic could be used and the processor could execute other numbers and types of programmed instructions.

The memory 20 stores these programmed instructions for one or more aspects of the present technology as described and illustrated by way of the examples herein, although some or all of the programmed instructions could be stored and executed elsewhere. A variety of different types of memory storage devices, such as a random access memory (RAM) or a read only memory (ROM) in the system or a floppy disk, hard disk, CD ROM, DVD ROM, or other computer readable medium which is read from and written to by a magnetic, optical, or other reading and writing system that is coupled to the processor 18, can be used for the memory 20.

The interface device 30 in the secured computing apparatus 12 is used to operatively couple and communicate between the secured computing apparatus 12 and client computing devices 14(1)-14(n) via the communication network 16, although other types and numbers of communication networks or systems with other types and numbers of connections and configurations can be used. By way of example only, the communications network could use TCP/IP over Ethernet and industry-standard protocols, including NFS, CIFS, SOAP, XML, LDAP, and SNMP, although other types and numbers of communication networks, such as a direct connection, a local area network, a wide area network, a personal area network, such as Bluetooth, modems and phone lines, e-mail, and wireless communication technology, each having their own communications protocols, can be used.

Each of the client computing devices 14(1)-14(n) includes a central processing unit (CPU) or processor, a memory, a user input device, a display device, and an interface or I/O system, which are coupled together by a bus or other link, although the client computing devices could comprise other numbers and types of devices, elements, and components in other configurations.

The processor in each of the client computing devices 14(1)-14(n) executes a program of stored instructions for one or more other aspects of the present technology as described and illustrated by way of the examples herein, although other types and numbers of processing devices and logic could be used and the processor could execute other numbers and types of programmed instructions.

The memory in each of the client computing devices 14(1)-14(n) stores these programmed instructions for one or more aspects of the present technology as described and illustrated by way of the examples herein, although some or all of the programmed instructions could be stored and executed elsewhere. A variety of different types of memory storage devices, such as a random access memory (RAM) or a read only memory (ROM) in the system or a floppy disk, hard disk, CD ROM, DVD ROM, or other computer readable medium which is read from and written to by a magnetic, optical, or other reading and writing system that is coupled to the processor in each of the client computing devices 14(1)-14(n), can be used for the memory in each of the client computing devices 14(1)-14(n). By way of example only, the client computing devices 14(1)-14(n) could comprise a laptop computing systems, desktop computing systems, tablets, smart phones, and PDAs, although other types of devices could be used.

Although examples of the secured computing apparatus 12 and the client computing devices 14(1)-14(n) coupled together via the communication network 16 are illustrated and described herein, each of these systems can be implemented on any suitable computer system or computing device. It is to be understood that the devices and systems of the examples described herein are for exemplary purposes, as many variations of the specific hardware and software used to implement the examples are possible, as will be appreciated by those skilled in the relevant art(s).

Furthermore, each of the systems of the examples may be conveniently implemented using one or more general purpose computer systems, microprocessors, digital signal processors, and micro-controllers, programmed according to the teachings of the examples, as described and illustrated herein, and as will be appreciated by those ordinary skill in the art.

In addition, two or more computing systems or devices can be substituted for any one of the systems in any embodiment of the examples. Accordingly, principles and advantages of distributed processing, such as redundancy and replication also can be implemented, as desired, to increase the robustness and performance of the devices and systems of the examples. The examples may also be implemented on computer device or devices that extend across any suitable network using any suitable interface mechanisms and communications technologies, including by way of example only telecommunications in any suitable form (e.g., voice and modem), wireless communications media, wireless communications networks, cellular communications networks, G3 communications networks, Public Switched Telephone Network (PSTNs), Packet Data Networks (PDNs), the Internet, intranets, and combinations thereof.

The examples may also be embodied as a non-transitory computer readable medium having instructions stored thereon for one or more aspects of the present technology as described and illustrated by way of the examples herein, as described herein, which when executed by a processor, cause the processor to carry out the steps necessary to implement the methods of the examples, as described and illustrated herein.

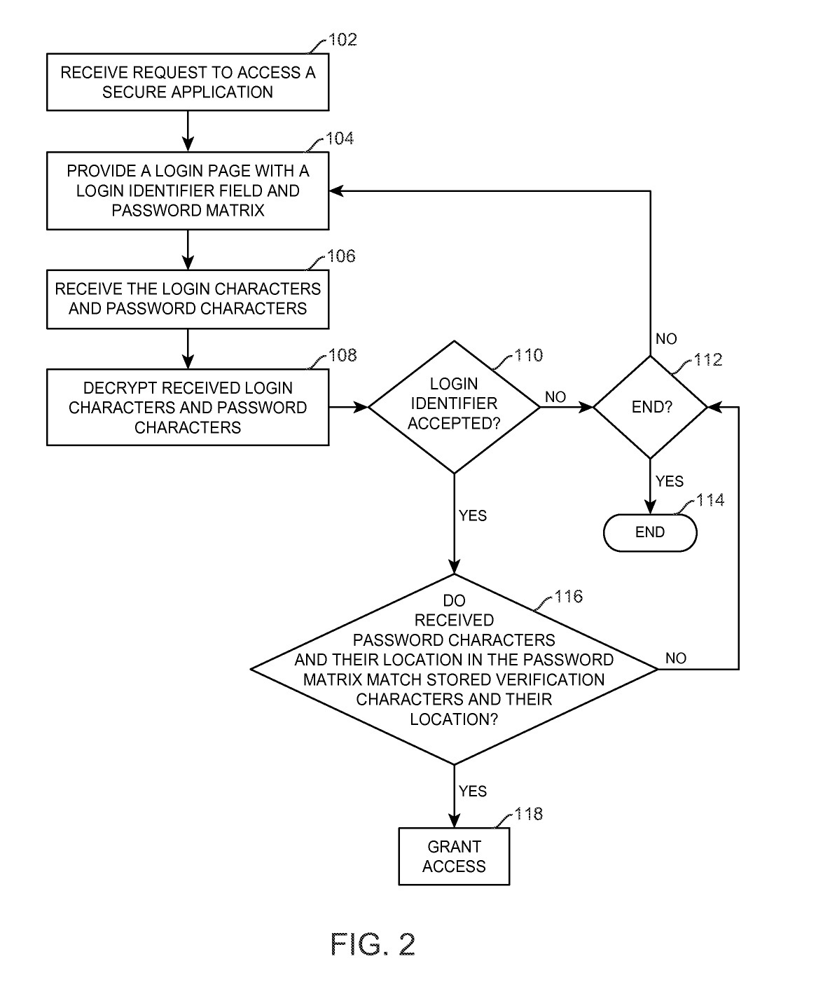

An exemplary method for enhancing password authentication is now described with reference to FIGS. 1-2. In step 102 the secured computing apparatus 12 receives a request to access a secure application hosted on the secured computing apparatus 12 from one of the client computing devices 14(1)-14(n), although other types of requests which require authentication could be used. Additionally, although in this example, the secured computing apparatus 12 also is hosting the requested secure content, other configurations can be used, such as the secured computing apparatus 12 acting a proxy server which handles authentication for one or more other computing devices.

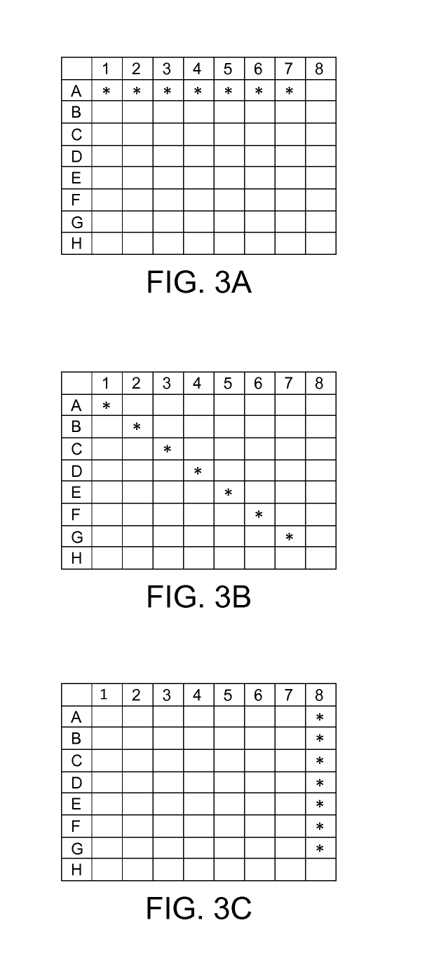

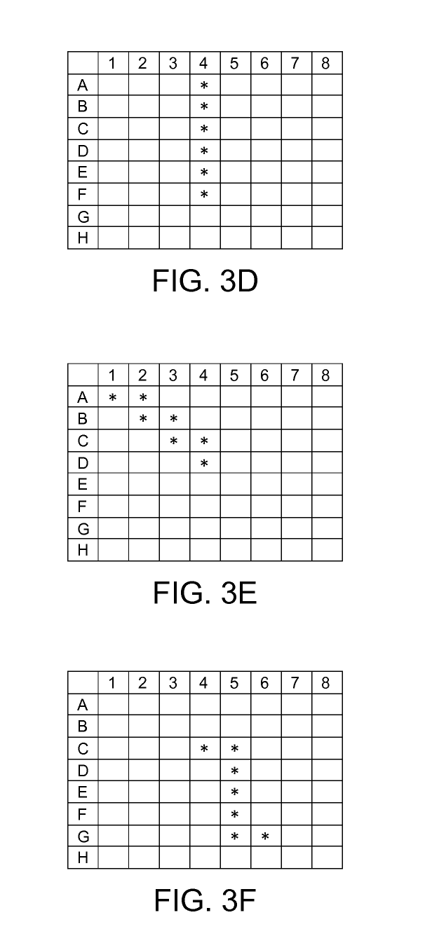

In step 104, in response to the received request the secured computing apparatus 12 transmits a login page with a login identifier field and a password matrix with a plurality of rows and columns to the requesting one of the client computing devices 14(1)-14(n), although other manners for requesting the login identifier and password characters can be used. Examples of an 8×8 password matrix are illustrated in FIGS. 3A-3F, although the password matrix can have other sizes, such as a 4×4 password matrix can be used.

In step 106, the secured computing apparatus 12 receives the login identifier characters entered in the login identifier field and the password characters entered in a subset of the password matrix in a unique pattern from the requesting one of the client computing devices 14(1)-14(n). The requesting one of the client computing devices 14(1)-14(n) when initially registering with the secured computing apparatus 12 for access will have selected a login identifier or username, a password comprising a plurality of characters, such as alphanumeric characters and other symbols, and also a subset pattern of entering the password characters which is stored by the secured computing apparatus 12. Examples of different unique patterns in the password matrix are illustrated in FIGS. 3A-3F for the password “welcome” which has been encrypted and is illustrated by asterisks.

In step 108, if the login identifier characters entered in the login identifier field and the password characters entered in a subset of the password matrix were encrypted, the secured computing apparatus 12 may decrypt the login identifier characters and the password characters.

In step 110, the secured computing apparatus 12 determines whether the received login identifier characters match any stored login identified characters for previously registered users from one of the client computing devices 14(1)-14(n), although other manners for validating a login identifier can be used. If in step 110, the secured computing apparatus 12 determines the received login identifier characters do not match any stored login identified characters, then the No branch is taken to step 112.

In step 112, the secured computing apparatus 12 determines whether to end this method based on a number of failed attempts to login, although other methods for determining when to end can be used. If in step 112, the secured computing apparatus 12 determines this method should end, then the Yes branch is taken to step 114 where this method ends. If in step 112, the secured computing apparatus 12 determines this method should not end, then the No branch is taken back to step 104 as described earlier to allow another attempt to gain secure access.

If back in step 110, the secured computing apparatus 12 determines the received login identifier characters do match stored login identified characters, then the Yes branch is taken to step 116. In step 116, the secured computing apparatus 12 uses the received login identifier to obtain verification password characters as well as the pattern of their particular location in the password matrix for the requesting one of the client computing devices 14(1)-14(n) to use for authentication, although other manners for obtaining the stored verification password characters and their location in the rows and columns of the password matrix can be used. Next, the secured computing apparatus 12 determines whether there is a match between each of the received password characters and its particular location in a row and column of the password matrix with each of the verification password characters and their stored location in the password matrix. If in step 116, the secured computing apparatus 12 determines at least one of the received password characters does not match one of the verification password characters or the location of one of the received password characters in the password matrix match does not match the location of the corresponding identified verification password character, then the No branch is taken back to step 112 as described earlier. Accordingly, with this technology even if an attacker is able to decrypt or otherwise obtain the password of the requesting one of the client computing devices 14(1)-14(n), the attacker would not be able to obtain the particular location pattern in which the received password characters need to be entered in the password matrix to be authenticated.

If in step 116, the secured computing apparatus 12 determines the received password characters and the location of each of the received password characters in the password matrix match each of the identified verification password characters and the location of each of the identified verification password characters in the password matrix, then the Yes branch is taken to step 118. In step 118, the secured computing apparatus 12 grants access to the secure application or other secure requested content to the authenticated requesting one of the client computing devices 14(1)-14(n).

Accordingly, as illustrated and described herein for typical single field password approach the number of possible combinations for n char password is n!. As a result, the number of possible combinations for an eight character password is 8×7×6×5×4×3×2×1=40320. With this technology, the number of combinations possible for an n char password entered in a unique pattern in a password matrix is 64Cn×n!. In this example, the 40,320 possible permutations of the password with eight characters could be entered in the matrix in 64C8 ways or 64×63×62×61×60×59×58×57=178,462,987,637,760 ways. This also assumes the number of password characters is known. When the number of password characters is not known, number of possible combinations becomes even greater. Thus, as illustrated and described with the example herein this technology provides improved methods and devices for enhancing password authentication. With this technology, it becomes very difficult, if not impossible, to gain unauthorized access even when access to the password itself is obtained.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for enhancing password authentication, the method comprising:
identifying, by a secured computing apparatus, verification password characters and a location of each of the verification password characters in one of a plurality of rows and one of a plurality of columns of a password matrix in response to received login identifier characters and received password characters from a client computing device;
determining, by the secured computing apparatus, whether each of the received password characters and the location of each of the received password characters in the password matrix matches each of the identified verification password characters and the location of each of the identified verification password characters in the password matrix; and
granting, by the secured computing apparatus, access to the client computing device when each of the received password characters and the location of each of the received password characters in the password matrix is determined to match each of the identified verification password characters and the location of each of the identified verification password characters in the password matrix.

2. The method of claim 1 further comprising providing, by a secured computing apparatus, a login field for entering the received login identifier characters and the password matrix for entering the received password characters in response to a request from the client computing device.

3. The method of claim 1 further comprising decrypting, at the secured computing apparatus, the received login identifier characters and the received password characters.

4. The method of claim 1 wherein the password matrix comprises at least four of the rows and fours of the columns.

5. The method of claim 1 wherein the received password characters and the verification password characters are in a subset of password matrix.

6. The method of claim 1 wherein the received password characters and the verification password characters extend between two or more of the rows of the password matrix.

7. The method of claim 1 denying, by the secured computing apparatus, access to the client computing device when at least one of the received password characters or the location of each of the received password characters in the password matrix is determined not to match at least one of the identified verification password characters or the location of each of the identified verification password characters in the password matrix.

8. A non-transitory computer readable medium having stored thereon instructions for enhancing password authentication comprising machine executable code which when executed by at least one processor, causes the processor to perform steps comprising:
identifying verification password characters and a location of each of the verification password characters in one of a plurality of rows and one of a plurality of columns of a password matrix in response to received login identifier characters and received password characters from a client computing device;
determining whether each of the received password characters and the location of each of the received password characters in the password matrix matches each of the identified verification password characters and the location of each of the identified verification password characters in the password matrix; and
granting access to the client computing device when each of the received password characters and the location of each of the received password characters in the password matrix is determined to match each of the identified verification password characters and the location of each of the identified verification password characters in the password matrix.

9. The medium of claim 8 further comprising providing a login field for entering the received login identifier characters and the password matrix for entering the received password characters in response to a request from the client computing device.

10. The medium of claim 8 further comprising decrypting the received login identifier characters and the received password characters.

11. The medium of claim 8 wherein the password matrix comprises at least four of the rows and fours of the columns.

12. The medium of claim 8 wherein the received password characters and the verification password characters are in a subset of password matrix.

13. The medium of claim 8 wherein the received password characters and the verification password characters extend between two or more of the rows of the password matrix.

14. The medium of claim 8 denying access to the client computing device when at least one of the received password characters or the location of each of the received password characters in the password matrix is determined not to match at least one of the identified verification password characters or the location of each of the identified verification password characters in the password matrix.

15. A secured computing apparatus comprising:
one or more processors;
a memory coupled to the one or more processors which are configured to execute programmed instructions stored in the memory comprising:
identifying verification password characters and a location of each of the verification password characters in one of a plurality of rows and one of a plurality of columns of a password matrix in response to received login identifier characters and received password characters from a client computing device;
determining whether each of the received password characters and the location of each of the received password characters in the password matrix matches each of the identified verification password characters and the location of each of the identified verification password characters in the password matrix; and
granting access to the client computing device when each of the received password characters and the location of each of the received password characters in the password matrix is determined to match each of the identified verification password characters and the location of each of the identified verification password characters in the password matrix.

16. The apparatus of claim 15 wherein the one or more processors is further configured to execute programmed instructions stored in the memory further comprising providing a login field for entering the received login identifier characters and the password matrix for entering the received password characters in response to a request from the client computing device.

17. The apparatus of claim 15 wherein the one or more processors is further configured to execute programmed instructions stored in the memory further comprising decrypting the received login identifier characters and the received password characters.

18. The apparatus of claim 15 wherein the password matrix comprises at least four of the rows and fours of the columns.

19. The apparatus of claim 15 wherein the received password characters and the verification password characters are in a subset of password matrix.

20. The apparatus of claim 15 wherein the received password characters and the verification password characters extend between two or more of the rows of the password matrix.

21. The apparatus of claim 15 wherein the one or more processors is further configured to execute programmed instructions stored in the memory further comprising denying access to the client computing device when at least one of the received password characters or the location of each of the received password characters in the password matrix is determined not to match at least one of the identified verification password characters or the location of each of the identified verification password characters in the password matrix.
